(19) United States
(12) Patent Application Publication
(10) Pub. No.: US 2003/0167640 A1
(43) Pub. Date: Sep. 11, 2003

(54) Pruners for cutting vegetation

(75) Inventors: Edward A. Heck, Belpre, OH (US); John R. Grishaber, Parkersburg, WV (US)

Correspondence Address: PILLSBURY WINTHROP, LLP, P.O. BOX 10500, MCLEAN, VA, 22102, US

(73) Assignee: AMES TRUE TEMPER, INC., Camp Hill, PA

(21) Appl. No.: 10/197,495

(22) Filed: Jul. 18, 2002

Related U.S. Application Data
(60) Provisional application No. 60/361,334, filed on Mar. 5, 2002.

(51) Int. Cl. B26B 13/00

(52) U.S. Cl. 30/253; 30/249

(57) ABSTRACT

A hand-operated pruner for trimming vegetation includes a main body having a cutting member and cutting blade mounted at a forward end thereof and a finger grip lever pivotably mounted at a rearward end. A linkage structure extends through a cavity in the main body and operatively interconnects the lever with at least one of the cutting member and the blade.

The present application claims priority to U.S. provisional patent application Serial No. 60/361,334 filed Mar. 5, 2002 which application is hereby incorporated in its entirety into the present application for all material disclosed therein.

### FIELD OF THE INVENTION

The present invention is generally related to lawn and garden equipment and is more particularly related to pruning devices for cutting vegetation such as plant stems and branches.

### BACKGROUND

Hand operated pruners are used in landscaping, horticulture, gardening and related fields to cut stems and branches of plants. Many pruners are comprised of a pair of elongated members which each have a handle portion at one end and a cutting member portion at an opposite end. Intermediate portions of the elongated members are pivotally connected to one another to give the pruners a pliers-like construction. The cutting members are moved to their closed position to cut vegetation by moving the handle portions toward one another.

When a pliers-type construction is used, the index and middle fingers of the worker's hand are relatively close to the central pivot point and the ring finger and little finger of the hand are relatively far from the central pivot point. The closer the fingers are to the pivot point, the lesser the degree of mechanical advantage or leverage the fingers have. Consequently, when the pliers-type construction is used, the relatively weaker fingers are positioned to have the greater mechanical advantage and the relatively stronger fingers are positioned to have the lesser mechanical advantage. This construction is not ergonomic and may cause the gripping hand to tire relatively quickly.

Some know cutting devices improve ergonomics by positioning the stronger fingers of the worker's hand to have better mechanic advantage. Examples of cutting devices which provide better mechanical advantage are found in U.S. Pat. Nos. 2,326,178 and 5,943,779. The disclosed embodiments of both of these patents include a lever pivotally mounted to a handle for pivotal movement and a pair of blades mounted to the handle. One blade is fixedly mounted with respect to the handle and the other blade is pivotally mounted with respect to the handle for movement between open and closed positions with respect to the fixed blade. The lever is operatively interconnected to the movable blade such that movement of the lever toward the handle moves the movable blade to its closed position. In each device, the relatively strong fingers (the thumb, and index and middle fingers) are positioned at the free end of the lever and therefore relatively far from the pivot point to improve leverage. The blades and the lever are pivotally mounted at the same end of the handle in both the '178 and the '779 cutting devices. This construction may be effective for performing easy cutting tasks where traditional-type scissors are used (e.g., cutting paper or cloth), but is not well suited for “tough jobs”, such as cutting stems and branches.

Another example of cutting devices in which the stronger fingers are positioned to have better mechanical advantage is shown in U.S. Pat. No. 3,572,192. The '192 patent shows examples of cutting devices in which an actuating lever is pivotally mounted to one end of a handle portion of the device and a pair of cutting members are pivotally mounted at an opposite end of the handle portion. The lever is directly slidably coupled to a portion of one of the cutting members and a spring structure is directly coupled to either the movable cutting member or to the lever so that when the lever is released, the spring moves the lever to its non-actuated position and the movable cutting member to its open position. The cutting members, the lever, the spring and the mechanical connection between the lever and the movable cutting member are exposed in each of the cutting devices shown in the '192 reference. This construction has several disadvantages. For example, this construction exposes the components and the mechanical connections therebetween to the environment which increases the chances that vegetation or the worker's skin or gloves may be pinched or caught in these components.

### SUMMARY OF THE INVENTION

An illustrative embodiment of the invention provides a hand-operated pruner for trimming vegetation, the pruners comprising a main body formed of rigid material and providing a blade mounting portion at a forward end thereof, a finger grip lever mounting portion at a rearward end thereof distal the blade mounting portion, a hand grip portion extending rearwardly from the blade mounting portion between the blade mounting portion and the finger grip lever mounting portion, and a linkage receiving cavity extending through the hand grip portion at least from the lever mounting portion to the blade mounting portion. The hand grip portion provides an exterior palm engaging surface configured to enable a user performing a vegetation cutting operation to engage a palm of his or her hand therewith. The pruners includes a pair of cooperating cutting members including at least one cutting blade, the cutting members each being mounted to the blade mounting portion of the main body for relative movement with respect to one another between an open position in which the cutting members are spaced apart from one another to enable vegetation to be positioned therebetween and a closed position in which the cutting members are adjacent one another, the cutting members cooperating with one another to sever vegetation positioned therebetween as the cutting members move from their open position toward and into their closed position to thereby perform the vegetation cutting operation. A finger grip lever formed of rigid material is pivotably mounted at a rearward end thereof to the finger grip lever mounting portion of the main body so as to extend forwardly therefrom and terminate in a free end. The finger grip lever is pivotable toward and away from the main body between a non-actuated position in which the lever forms a relatively larger angle with the main body, and an actuated position in which the lever forms a relatively smaller angle with the main body. The finger grip lever and the main body are constructed and arranged such that when a palm of a gripping hand of a user is engaged with the palm engaging surface between the blade mounting portion and the finger grip lever mounting portion, a plurality of fingers of the gripping hand are positioned on the finger grip lever such that when the user moves the finger grip lever from its non-actuated position toward and into its actuated position, an index finger of the user is positioned at or near the free forward end of the finger grip lever. A linkage structure extends through the linkage receiving cavity of the main body and operatively interconnects the finger grip lever with at least one of the cutting members such that pivotal movement of the finger grip lever from its non-actuated position toward and into its actuated position causes relative movement between the cutting members toward and into their closed position. A spring structure biases the finger grip lever toward and into its non-actuated position and the cutting members relative to one another toward and into their open position.

Other aspects, features, and advantages of the present invention will become apparent from the following detailed description, the accompanying drawings, and the appended claims.

### BRIEF DESCRIPTION OF THE DRAWINGS

FIG. 1 is a perspective view of an illustrative embodiment of a pair of pruners constructed according to the principles of the invention;

FIG. 2 is a side elevational view of the pruners of FIG. 1;

FIG. 3 is a view similar to FIG. 2 except showing a housing half of the pruners removed to show the interior structure of the pruners;

FIG. 4 is a view similar to FIG. 3 except showing the pruners in their actuated position;

FIG. 5 is a perspective view of an illustrative embodiment of another pair of pruners constructed according to the principles of the present invention;

FIG. 6 is an exploded view of the pruners of FIG. 5;

FIG. 7 is a side elevational view of the pruners of FIG. 5;

FIG. 8 is a view similar to FIG. 7 except showing an opposite side of the pruners;

FIG. 9 is a fragmentary view of the pruners taken along the line of sight 9-9 as indicated in FIG. 8;

FIG. 10 is a cross-sectional view of the pruners taken along the line 10-10 of FIG. 8;

FIG. 11 is a view similar to the view of FIG. 8 except showing the pruners in cross-section;

FIG. 12 is a view similar to FIG. 11 except showing the pruners in its actuated position; and

FIG. 13 is a fragmentary view of the pruners taken along the line of sight 13-13 of FIG. 8 and showing the pruners in partially exploded view.

### DETAILED DESCRIPTION OF THE INVENTION

The present invention is generally directed to pruners for cutting plant stems, branches and other vegetative matter, and is more particularly related to pruners having an actuation lever pivotally mounted on one end of a gripping or handle portion thereof and having a pair of cutting members mounted at an opposite end thereof. The actuation lever is operatively connected to the cutting members and is operable to move the cutting members from their open position toward and into their closed position. This arrangement positions the stronger index and middle fingers of a worker's hand relatively far from the point at which the lever is pivotally attached to the handle portion and positions the weaker ring and little fingers nearer the point where the lever pivotally attaches to the handle portion. This arrangement positions the stronger fingers at or near the free end of the lever where they have the greatest mechanical advantage to facilitate cutting operations and to lessen the fatiguing of the worker's hand.

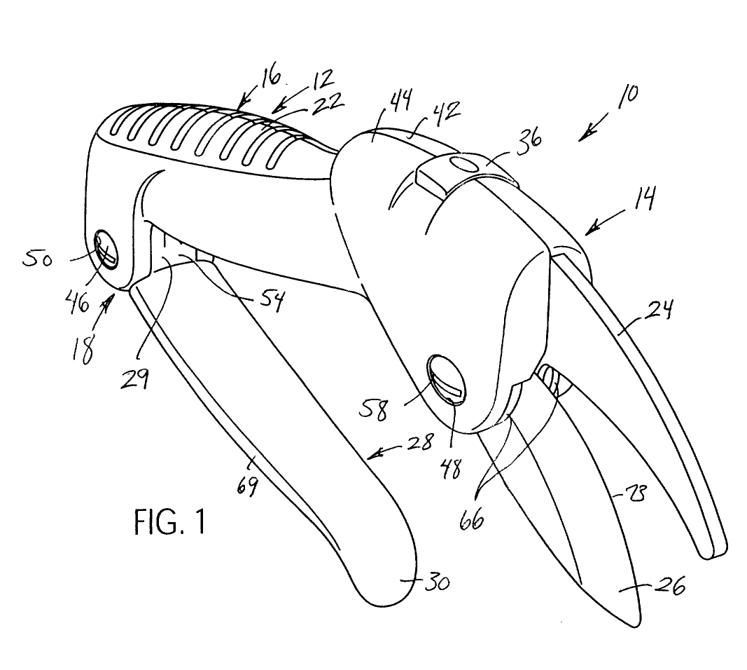

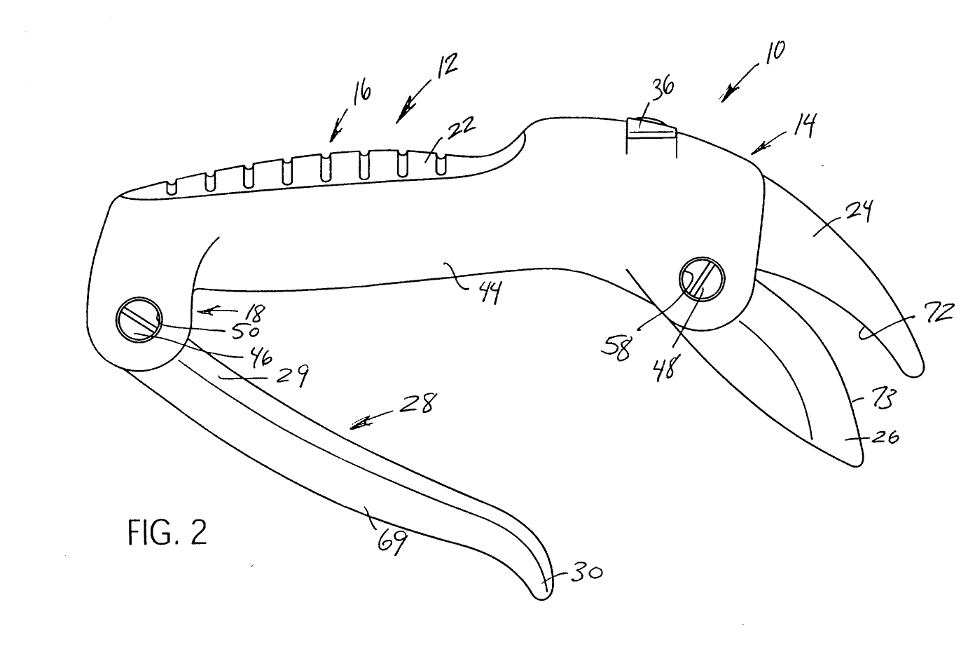

FIGS. 1-4 show an illustrative embodiment of a pair of hand-operated pruners 10 for trimming vegetation. The pruners 10 includes a main body 12 formed of rigid material. The main body 12 provides a blade mounting portion 14 at a forward end thereof, a hand grip or handle grip portion 16 extending rearwardly from the blade mounting portion 14, a finger grip lever mounting portion 18 at a rearward end thereof distal or distant from the blade mounting portion 14, and a linkage receiving cavity 20 extending through the hand grip portion 16 from the lever mounting portion 18 to the blade mounting portion 14. The hand grip portion 16 provides an exterior palm engaging surface 22 configured to enable a worker performing a vegetation cutting operation to engage a palm of his or her hand therewith.

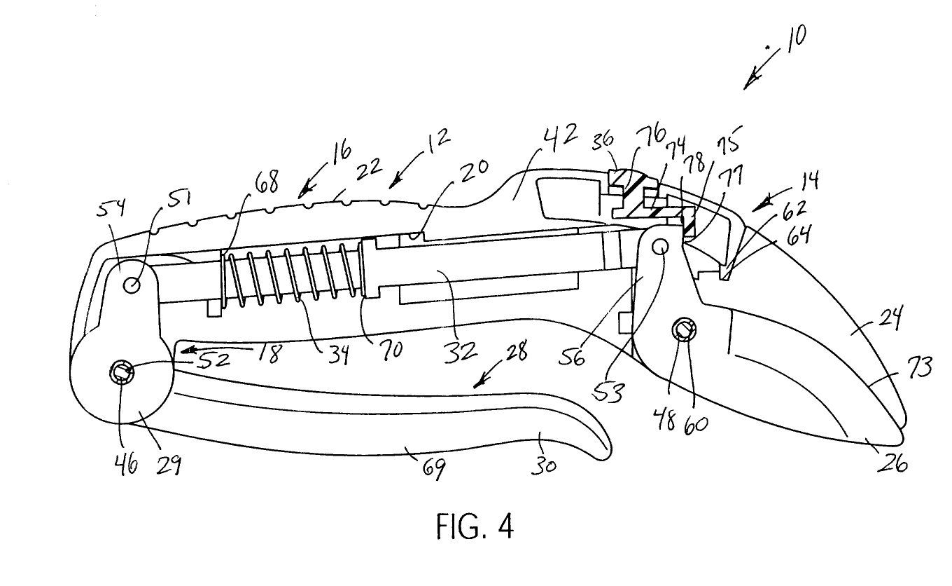

The pruners 10 include a first cutting member which may be provided in the form of a first cutting blade 24 constructed of a rigid material suitable for cutting vegetation and a second cutting member which may be in the form of a second cutting blade 26. The cutting blade 24 and the second cutting member 26 are each mounted to the blade mounting portion 14 of the main body 12 for relative movement with respect to one another between an open position (see FIGS. 1-3, for example) in which at least a portion of each of the first cutting blade 24 and the second cutting member 26 are spaced apart from one another sufficiently to expose the cutting edge of the cutting blade 24 to enable vegetation to be positioned therebetween and a closed position (see FIG. 4, for example) in which the first cutting blade 24 and the second cutting member 26 are adjacent one another.

The first cutting blade 24 and the second cutting member 26 are constructed and arranged to cooperate with one another to sever vegetation positioned therebetween as the first cutting blade 24 and the second cutting member 26 move from their open position toward and into their closed position and thereby perform the vegetation cutting operation. A finger grip lever 28 formed of rigid material is pivotably mounted at a rearward end 29 thereof to the finger grip lever mounting portion 18 of the main body 12 and extends forwardly therefrom and terminates in a free end 30. The finger grip lever 28 is mounted for pivotal movement with respect to the main body 12 between a non-actuated position (see FIGS. 1-3, for example) in which the lever 28 forms a relatively larger angle with the main body 12 and an actuated position (see FIG. 4) in which the lever 28 forms a relatively smaller angle with the main body 12.

The finger grip lever 28 and the main body 12 are constructed and arranged such that when a palm of a gripping hand of a worker is engaged with the palm engaging surface 22, a plurality of fingers of the gripping hand are positioned on the finger grip lever 28 such that when the worker moves the finger grip lever 28 from its non-actuated position toward and into its actuated position, an index finger of the worker is positioned at or near the free forward end 30 of the finger grip lever 28.

A linkage structure 32 extends through the linkage receiving cavity 20 of the main body 12 and operatively interconnects the finger grip lever 28 with at least one of the cutting member 26 and the cutting blade 24 such that pivotal movement of the finger grip lever 28 from its non-actuated position toward and into its actuated position causes relative movement between the cutting blade 24 and the cutting member 26 toward and into their closed position.

Spring structure in the form of a coil spring 34 is operatively engaged with the finger grip lever 28 and with at least one of the cutting blade 24 and the cutting member 26 to move the finger grip lever 28 toward and into its non-actuated position and to cause relative movement between the cutting member and the cutting blade toward and into their open position.

A releasable lock 36 is carried on the main body 12 and is movable between (a) a locked position wherein the lock 36 retains the cutting blade 24 and the cutting member 26 in their closed position and retains the finger grip lever 28 in its actuated position against the biasing of the spring structure 34 and (b) an unlocked position wherein the cutting blade 24 and the cutting member 26 are movable between their open and closed positions and the finger grip lever 28 is movable between its actuated and non-actuated positions.

The cutting blades 24, 26 are mounted to the blade mounting portion 14 of the main body 12 and extend generally forwardly therefrom. The cutting blade 24 of the illustrative embodiment is fixed to the main body 12 and does not move relative thereto during a cutting operating. The cutting blade 26 is movable relative to the main body 12 and to the fixed cutting blade 24. The cutting blades 24, 26 are formed of a rigid material suitable for severing vegetation. Examples of appropriate materials include a metal material such as steel, a plastic material, a composite material, and so on.

It can be appreciated that the configuration of the pruners 10 in which both cutting members are blades is not required by the invention and is therefore illustrative and is not intended to limit the scope of the invention. For example, one or the other of the cutting members could be constructed to be an anvil-type structure that provides a support surface for a portion of a workpiece and which cooperates with a cutting edge of an opposing blade during a cutting operation to cut vegetation.

It can also be appreciated that although an illustrative embodiment of the pruners 10 includes one movable cutting member and one non-moving cutting member, this is not intended to limit the scope of the present invention. For example, a pair of pruners could be constructed so that both of the cutting members are movable (e.g., pivotally movable or, alternatively, reciprocally/rectilinearly movable) with respect to one another and with respect to the main body 12 or a pair of pruners could be constructed so that one of the cutting members moves (e.g., pivotally or, alternatively, reciprocally/rectilinearly) with respect to the handle portion of the pruners and with respect to the other cutting member during a cutting operation and so that the other cutting member is stationary with respect to the handle portion of the pruners during a cutting operation.

In instances in which one or both of the cutting members is a blade or other structure having a cutting edge, each of the cutting members may be removably mounted to the blade mounting portion of the main body 12 so that each cutting blade can be removed therefrom and replaced with a new blade. An example of a suitable mounting assemblies that could be incorporated into any of the illustrative embodiments of pruners the present invention to removably mount one or more blades is disclosed and described in commonly assigned U.S. patent application Ser. No. 09/968,662 which application is hereby incorporated by reference in its entirety into the present application for all material disclosed therein.

The finger grip lever 28 provides an exterior finger engaging surface 37 facing generally in the opposite direction of the palm engaging surface 22 on the main body 12. The finger engaging surface 37 is configured to enable the user performing the vegetation trimming operation to engage his or her fingers therewith with his or her index finger (and middle finger) positioned at or near the free end 30 when his or her palm is engaged with the palm engaging surface 22. The index finger and the middle finger are usually stronger than the other two fingers and in this arrangement are positioned more distant from the pivot point during the cutting operation than the other two fingers, thereby positioning the strong finger(s) where they have the greatest leverage.

The linkage structure 32 interconnects the rearward end portion 29 of the finger grip lever 28 with the cutting blades 24, 26 such that pivotal movement of the finger grip lever 28 towards the main body 12 affected by the user squeezing his or her fingers toward his or her palm when his or her palm and fingers are respectively engaged with the palm engaging surface 22 and the finger engaging surface 37 as aforesaid, a force is transmitted to the cutting blade 26 to cause the blades 24, 26 to close.

The main body 12 of the example pruners 10 includes two body halves 42, 44 that are connected together by threaded fasteners 46, 48. Each body half 42, 44 includes an opening 50 in the lever mounting portion 18 thereof. The threaded fastener 46 extends through the openings 50 in the body halves 42, 44 and through an opening 52 through the finger grip lever 28. The linkage structure 32 is pivotally connected between an arm structure 54 integrally formed on the rearward end portion 29 of the finger grip lever 28 and an arm structure 56 integrally formed on the movable cutting blade 26 by fasteners 51, 53, respectively, which may be rivets, for example, or any other suitable structure. The fastener 48 extends through a pair of openings 58 formed in the blade mounting portion 14 of each respective body half 42, 44. The fastener 48 is mounted through an opening 60 in the movable cutting blade 26 and the cutting blade 26 is pivotally mounted around the fastener 48.

The fastener 48 is mounted in an opening (not shown) through the fixed cutting blade 24. A wall structure 62 integrally formed on the body half 42 of the main body 12 is disposed within a groove 64 formed in the fixed cutting blade 24. The engagement between the opening (not shown) in the fixed blade 24 and the fastener 48 and between the wall structure 62 and the groove 64 holds the cutting blade 24 in a fixed position with respect to the main body 12. The cutting blades 24, 26 are mounted immediately adjacent one another (that is, in side-by-side relation to one another) on the fastener 48 and a pair of washers 66 (see FIG. 1, for example) are mounted on the fastener 48 on opposite sides of the cutting blades 24, 26.

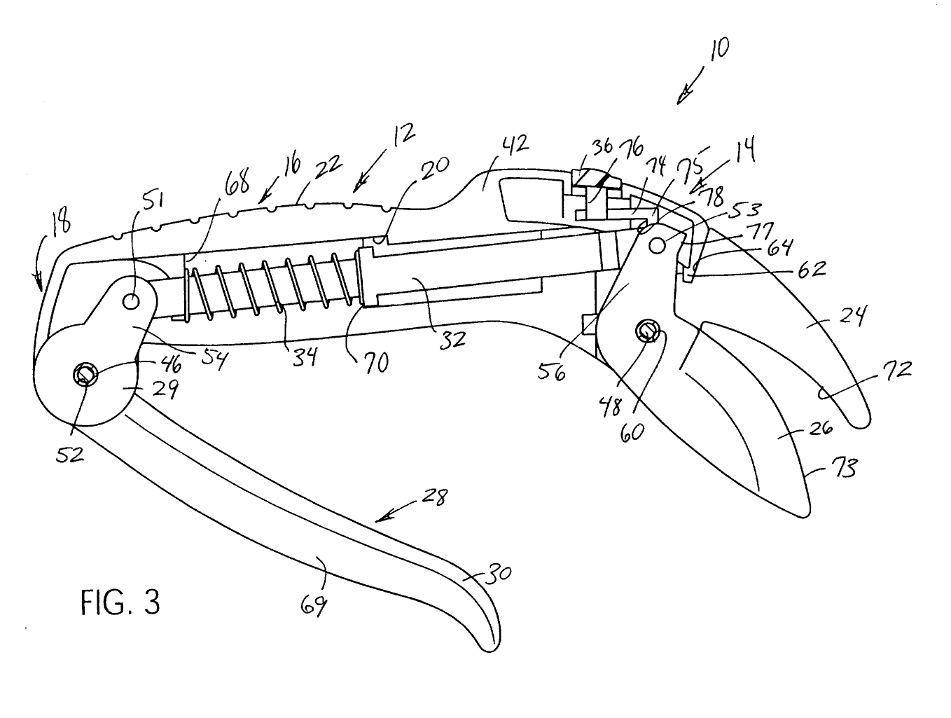

The coil spring 34 is mounted around an intermediate portion of the linkage structure 32 (see FIGS. 3 and 4). Each housing half 42, 44 may be of integral one-piece construction and may be constructed, for example, of a molded plastic material of suitable strength or of other suitable material such as a metal material, a composite material, and so on. Each housing half 42, 44 is shaped to include a spring support structure 68 that engages and supports one end of the coil spring 34. Only the spring support structure 68 on the housing half 42 is shown in the figures, but the spring support structure on the housing half 44 is essentially of identical construction to the spring support structure 68 and is laterally aligned with the structure 68 when the two housing halves are secured to one another.

The linkage structure 32 may also be of integral one-piece construction and may be constructed, for example, of a molded plastic material of suitable strength or of other suitable material such as a metal material, a composite material, and so on. The linkage structure 32 is shaped to include an integral spring support structure 70 that engages and supports an opposite end of the coil spring 34.

The operation of the pruners 10 can be understood from an examination of FIGS. 3 and 4. The worker generally places his or her palm on the palm engaging surface 22 of the main body 12 and wraps his or her fingers generally around a finger engaging surface 69 on the finger grip lever 28. Vegetation (not shown), which may be in the form of plant stems or branches, for example, is placed between the cutting blades 24, 26 when the blades 24, 26 are in their open position. The worker then squeezes his or her hand to move the finger grip lever 28 pivotally relative to and toward the main body portion 12 about the pivot point provided by the fastener 46.

The pivotal movement of the finger grip lever 28 toward the main body portion 12 causes the arm structure 54 on the finger grip lever 28 to pivot (in a counterclockwise direction from the point of view of FIGS. 3 and 4) generally toward the rear of the main body 12 which moves the linkage structure 32 rearwardly within the linkage receiving cavity 20. As the linkage structure 32 moves rearwardly, the spring support structure 70 on the linkage structure 32 moves toward the spring support structures 68 on the main body 12 which compresses the coil spring 34. The compressed coil spring 34 tends to bias the linkage structure 32 to move forwardly with respect to the main body 12 through the linkage receiving cavity 20.

The rearward movement of the linkage structure 32 with respect to the main body 12 through the linkage receiving cavity 20 pivots the arm structure 56 on the movable blade structure 26 generally rearwardly with respect to the main body 12 which causes the movable cutting blade 26 to pivot in its closing direction about the pivot point provided by the fastener 48 toward and into its closed position (see FIG. 4, for example). As the movable cutting blade 26 moves toward its closed position, the cutting edges 72, 73 of the blades 24, 26, respectively, cooperate to cut the vegetation disposed between the blades 24, 26.

As previously mentioned, it can be appreciated that the pruners 10 are illustrative of the invention and are thus not intended to limit the scope of the invention. Other embodiments of the pruners 10 are contemplated and within the scope of the present invention. For example, the pruners could be constructed such that both blades 24, 26 are movably mounted with respect to the main body 12 and are operatively connected to the linkage structure 32. As another example, a pruner could be constructed which includes an anvil structure and a cutting blade. One of the anvil and the blade could be pivotally mounted to the main body and operatively connected to the linkage structure and the other of the anvil and the blade could be fixedly mounted to the main body. As another alternative, both the anvil and the blade could be pivotally mounted to the main body and operatively connected to the linkage structure.

When the worker releases a finger grip lever 28, the spring force exerted by the coil spring 34 on the spring support structure 68 on the main body 12 and the spring support structure 70 on the linkage structure 32 causes the linkage structure 32 to move forwardly relative to the main body 12 within the linkage receiving cavity 20. This spring biased movement of the linkage structure 32 causes the movable cutting blade 26 to pivot back to its open position and causes the finger grip lever 28 to pivot back to the position that corresponds to the open position of the cutting blades 24, 26, that is, its non-actuated position.

The releasable lock 36 may be an integral structure constructed of a plastic material or other suitable material such as a metal material. The lock 36 is shaped to include a lock arm 74 and a lock tab 75. The lock 36 is slidably disposed in a lock opening 76 formed by the cooperation of the housing halves 42, 44 for sliding movement in a lateral or side-to-side direction with respect to the main body 12. When the lock 36 is in its releasing position (see FIG. 3), the tab 75 is positioned to the side of the movable blade 26 and therefore does not interfere with its movement between open and closed positions. When the movable blade 26 is held in its closed position by holding the lever 28 in its actuated position, the arm portion 56 of the blade 26 is positioned to allow the lock to move from its releasing position to its locked position (see FIG. 4). The movement of the lock 36 into its locked position causes the tab 75 to move laterally into the path of movement of the blade 26. When the blade 26 is released by releasing the lever 28 with the lock in its locked position, a locking surface 77 on the movable blade 26 abuttingly engages a rearwardly facing locking surface 78 on the tab 75 to releasably lock the blade 26 in its closed position and to releasably lock the lever 28 in its non-actuated position. The locked configuration of the pruners 10 is shown in FIG. 4.

The blade 26 and lever 28 can be unlocked by moving the lock 36 back to its releasing position. The worker may squeeze the lever 28 into its actuated position to relieve the pressure on the tab 75 to facilitate releasing of the lock 36.

The tab 75 may be provided with structure to help prevent accidental releasing of the lock (in the event that the locked pruner is dropped, for example). The tab 75 may be provided with a groove or recess for example that is sized to receive a portion of the blade 26 therein. Engagement of the groove with the blade would prevent lateral movement of the lock 36 toward and into its releasing position until the lever 28 is positively squeezed into its fully actuated position by the worker to prevent accidental release of the lock 36.

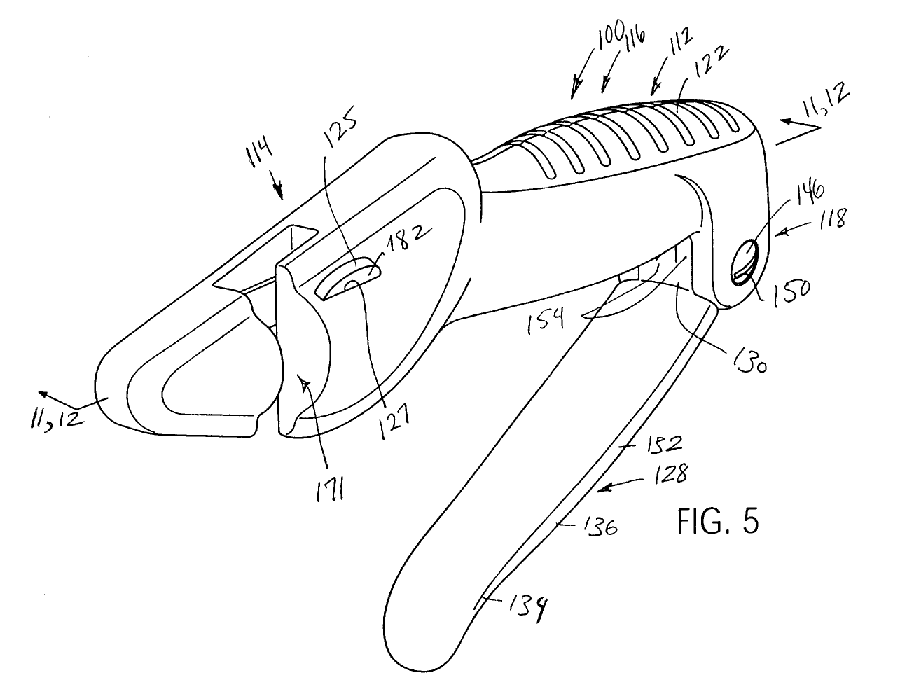

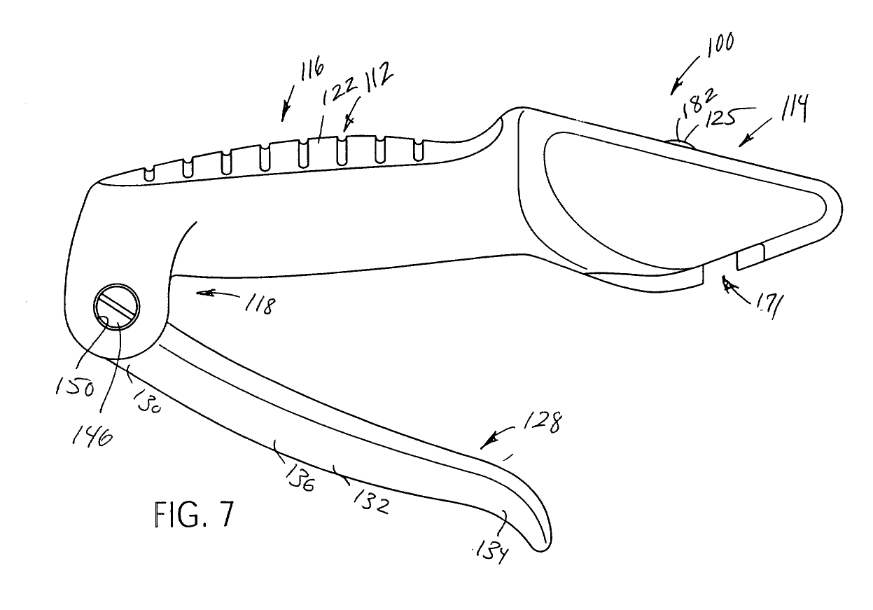

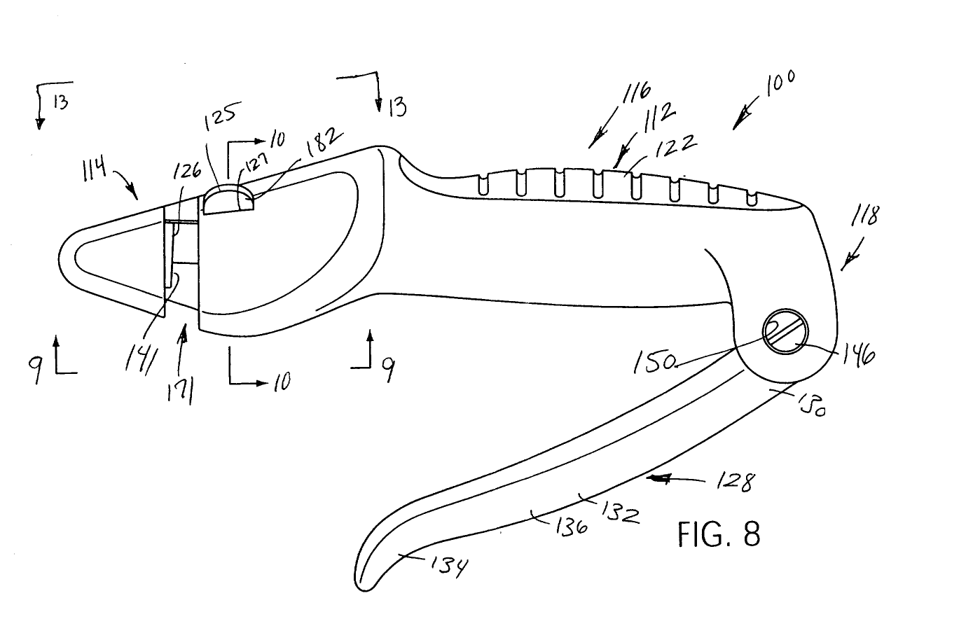

FIGS. 5-12 show another illustrative embodiment of a hand-operated pruner 100 for trimming vegetation. The pruners 100 includes a main body 112 formed of rigid material. The main body 112 may be of integral one-piece construction and may be constructed of a suitable molded plastic or other appropriate material such as a metal material or a composite material. The main body 112 is shaped to provide a blade mounting portion 114 at a forward end thereof, a hand grip portion 116 extending rearwardly from the blade mounting portion 114, a lever mounting portion 118 at a rearward end thereof distal or distant from the blade mounting portion 114, and a linkage receiving cavity 120 extending through the hand grip portion 116 generally from the blade mounting portion 114 to the lever mounting portion 118. The hand grip portion 116 includes a palm engaging surface 122 configured to enable a user performing a vegetation trimming operation to engage a palm of his or her hand therewith.

A cutting blade 124 and a cutting member 126 are each mounted to the blade mounting portion 114 of the main body 112 for relative movement with respect to one another between an open position in which the cutting blade 124 and the cutting member 126 are spaced apart from one another and a closed position in which the cutting blade 124 and the cutting member 126 are adjacent one another. The cutting blade 124 and the cutting member 126 cooperate with one another to sever vegetation positioned therebetween as the cutting blade 124 and the cutting member 126 move from their open position toward and into their closed position.

The cutting blade 124 and the cutting member 126 are each mounted within a forward end of the linkage receiving cavity 120. In the illustrative embodiment, the blade 124 extends generally across a proximal or forward end of the linkage receiving cavity 120 and is fixedly secured with respect to the main body 112 and therefore does not move relative to the main body 112 during a cutting operating.

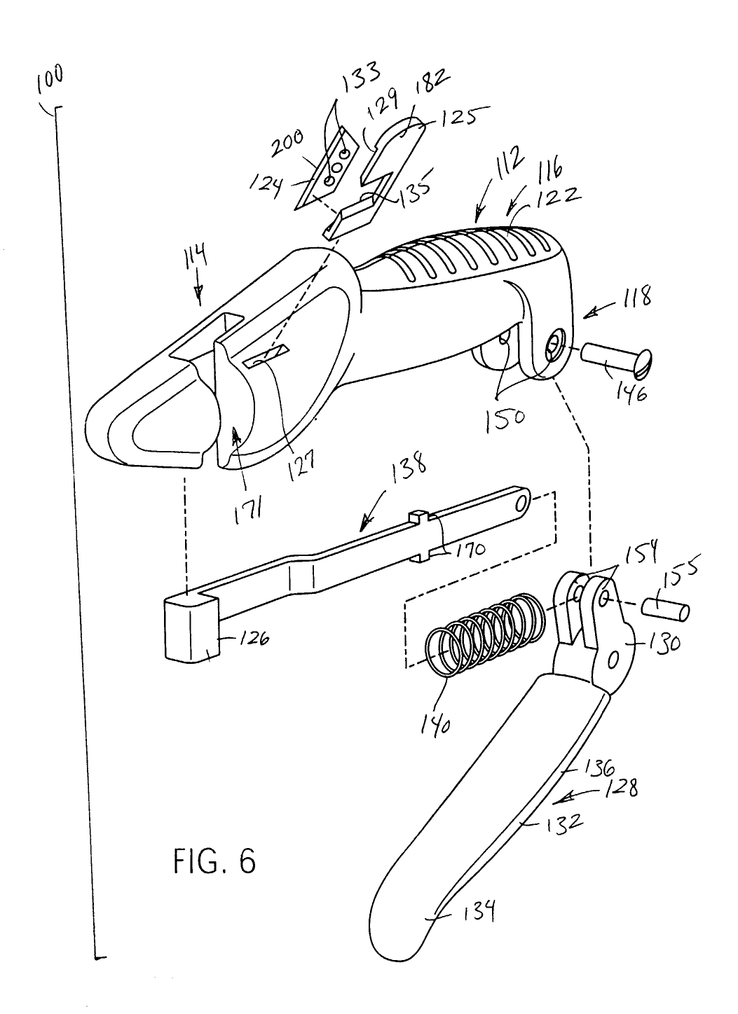

The cutting blade 124 is provided in the form of a removable blade releasably mounted on a blade holder or carrier 125 (see FIGS. 6, 8-10 and 13, for example). The blade carrier 125 is removably mounted to the main body 112 for movement between engaged and disengaged positions with respect to the main body 112. The cutting blade or blade member 124 is removably mounted on the blade carrier 125 such that when the blade 124 is mounted on the blade carrier 125 and the blade carrier 125 is engaged with the main body 112, the blade 124 is positioned in the linkage receiving cavity 120. The blade carrier 125 can be disengaged from the main body 112 so that the blade 124 can be removed from the blade carrier 125 and replaced with a new blade.

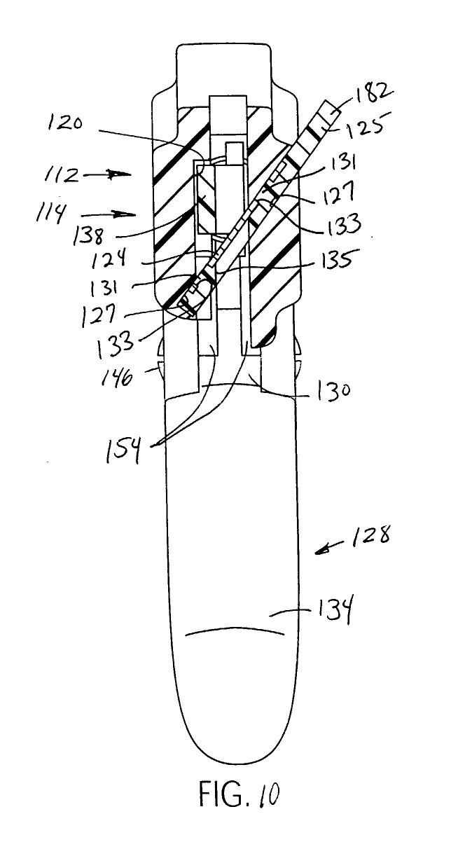

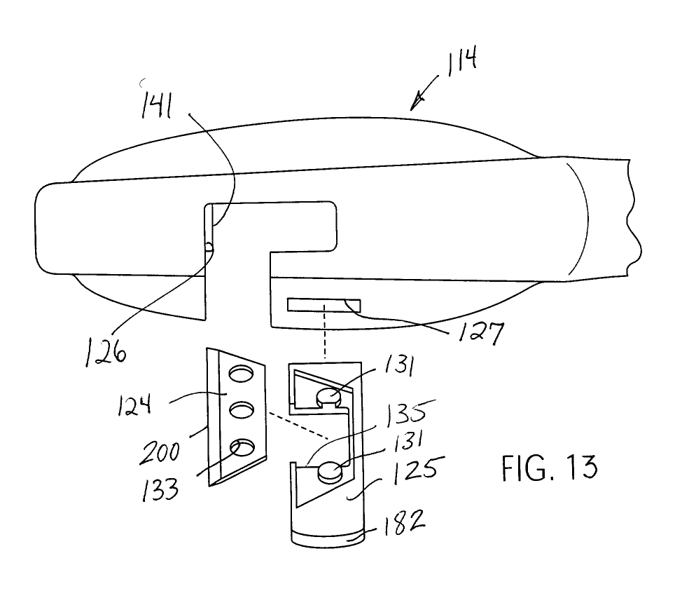

The blade carrier 125 is removably mounted within a slot 127 formed in the main body 112 of the pruners 100. The blade carrier 125 includes a recess 129 shaped to receive the blade 124 and a pair of posts 131 (see FIGS. 10 and 13, for example) that releasably lockingly engage a pair of openings 133 formed in the blade 124. The recess 129 and the posts 131 support the blade 124 and hold the blade 124 in a fixed position with respect to the carrier 125 during a cutting operation. A notch 135, the purpose of which is described below, is formed in the blade carrier 125.

The cutting blade 124 is formed of a rigid material suitable for severing vegetation. The example replaceable blade 124 may be constructed of steel, for example.

The pruners 100 further includes a finger grip lever 128 that is formed of rigid material and is pivotally mounted to the main body 112. The finger grip lever 128 includes a rearward end portion 130 and a finger grip portion 132. The rearward end portion 130 is pivotably mounted to the finger grip lever mounting portion 118 of the main body 112. The finger grip lever 128 is positioned generally opposite the palm engaging surface 122 on the main body 112. The finger grip portion 132 of the lever 128 extends forwardly from the point of pivotal attachment with the main body 112 and terminates in a free end 134. The construction and operation of the lever 128 is essentially identical to the construction and operation of the lever 28.

The finger grip lever 128 provides an exterior finger engaging surface 136 facing generally in the opposite direction of the palm engaging surface 122 on the main body 112. The finger engaging surface 136 is configured to enable the user performing the vegetation trimming operation to engage his or her fingers therewith with his or her index finger (and middle finger) positioned at or near the free forward end 134 when his or her palm is engaged with the palm engaging surface 122. The index finger and the middle finger are usually stronger than the other two fingers and in this arrangement these relatively strong fingers are positioned at or near the free end 134 and more distant from the pivot point between the main body 112 and the finger grip lever 128 during the cutting operation than the other two fingers, thereby positioning the strong fingers where they have the greatest leverage.

A linkage structure 138 extends through the linkage receiving cavity 120 of the main body 112 and is operatively connected between the finger grip lever 128 and the cutting member 126. The cutting member 126 may be integrally formed at the forward end of the linkage structure 138 (as shown in the example pruner 100 as shown, for example, in FIG. 6) or, alternatively, may be connected to the linkage structure 138. The cutting member 126 is shaped to provide an anvil-like structure that includes a workpiece engaging surface 141.

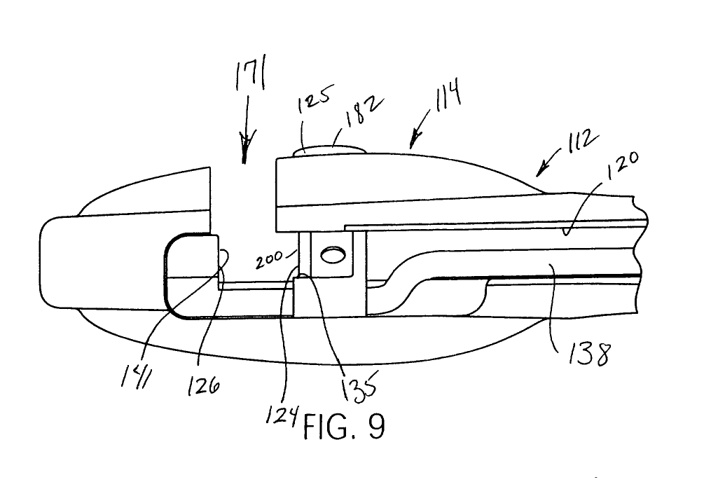

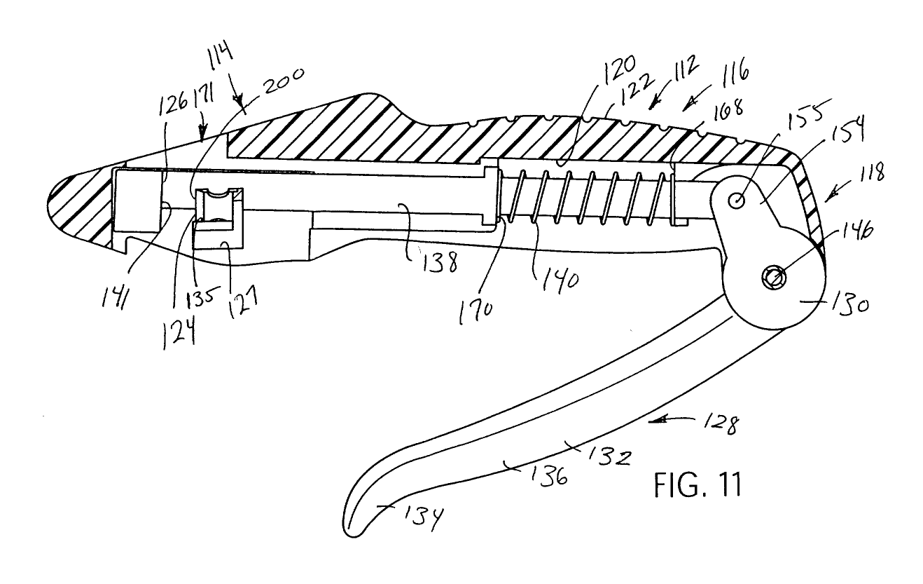

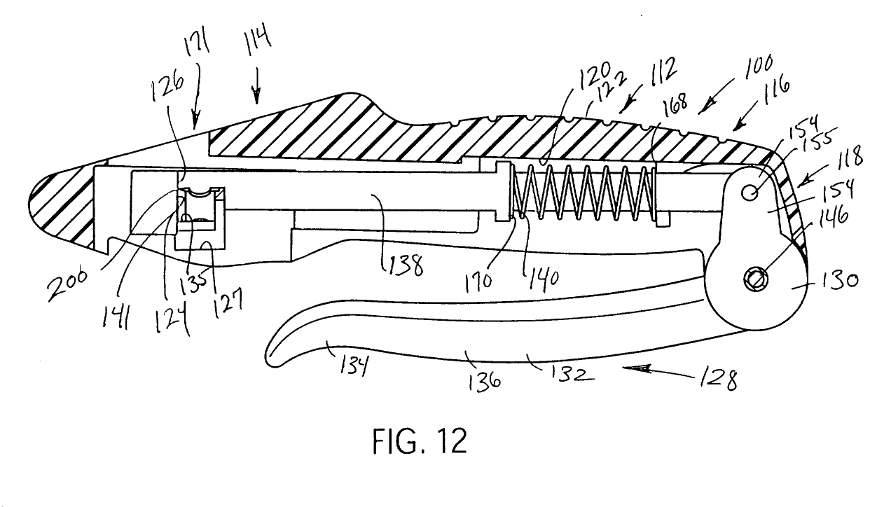

The cutting member 126 is operable to move a workpiece (such as the stem of a flower) against the cutting edge 200 of the blade 124. Thus, the linkage structure 138 is operatively connected to the finger grip lever 128 such that when the finger grip lever 128 moves from its non-actuated position (see FIG. 11, for example) to its actuated position (see FIG. 12, for example), the cutting member 126 moves from a position spaced from the cutting edge 200 of the blade 124 (see FIGS. 9 and 11, for example) to a position in which the workpiece engaging surface 141 thereof is in contact with the cutting edge 200 of the blade 124 (see FIG. 12, for example). Similarly, when the finger grip lever 128 moves from its actuated position back to its non-actuated position, the cutting member 126 moves from its closed position against the cutting edge 200 of the blade 124 to its open position in which it is spaced from the cutting edge 200 of the blade 124.

The linkage structure 138 extends forwardly through the linkage receiving cavity 120 from the rearward end portion 130 of the finger grip lever 128 to the forward end of the main body 112 for reciprocal movement with respect to the blade 124.

It can also be appreciated that although the illustrative embodiment of the pruners 100 includes one movable cutting member and one nonmoving cutting member, this is not intended to limit the scope of the present invention. For example, the pair of pruners 100 could be constructed so that both of the cutting members are movable (e.g., reciprocally/rectilinearly) within the cavity with respect to one another and with respect to the main body. In instances in which both cutting members are movably mounted within the cavity, one the cutting members could be an anvil and the other cutting member could be a cutting blade or, alternatively, both cutting members could be cutting blades.

In instances in which one cutting member is mounted in a fixed location in the cavity, the fixed member could be a blade or an anvil and the movable cutting member could be a blade or an anvil (as long one of the cutting members provides a cutting blade). In instances in which one or both of the cutting members of the pruner 100 is a blade or other structure having a cutting edge, each of the blades may be removably mounted to the blade mounting portion of the main body 12 so that each cutting blade can be removed therefrom and replaced with a new blade.

The pruners 100 includes a spring structure in the form of a coil spring 140 that is constructed and arranged to bias the cutting member 126 toward and into its open position and to bias the finger grip lever 128 to a position corresponding to the open position of the cutting member 126 (that is, to its non-actuated position).

A pair of openings 150 are formed in the lever mounting portion 118 of the main body 112. A threaded fastener 146 extends through the openings 150 and through an opening 152 formed in the finger grip lever 128 to pivotally mount the finger grip lever 128 to the main body 112. The linkage structure 138 is pivotally connected to a pair of arm structures 154 integrally formed on the rearward end portion 130 of the finger grip lever 128 by a fastener 155 (which may be a rivet, for example, or other appropriate structure).

The coil spring 140 is mounted around an intermediate portion of the linkage structure 138. The main body 112 includes a pair of spring support structures 168 (only one is shown, see FIGS. 11 and 12, for example) that engage and support one end of the coil spring 140. The linkage structure 138 includes a spring support structure 170 that engages and supports an opposite end of the coil spring 140.

The operation of the pruners 100 can be understood from examination of FIGS. 11-12 in particular. The worker generally places the palm of a gripping hand (not shown) on the palm engaging surface 122 of the main body 112 and wraps the fingers of the gripping hand around the finger engaging surface 136 of the finger grip lever 128. Vegetation (not shown) is placed between the cutting blade 124 and the cutting member 126.

A slot or side opening 171 into the cavity (see FIGS. 5, 6, 8 and 9, for example) is provided in a side of the main body 112 to facilitate the placement of a workpiece (such as a flower stem or branch) between the engaging surface 141 of the cutting member 126 and the cutting edge 200 of the blade 124. The worker squeezes the hand gripping the pruners 100 to pivot the main body portion 112 and the finger grip lever 128 about the pivot point provided by fastener 146 toward one another. The pivotal movement of the finger grip lever 128 toward the main body portion 112 causes the arm structure 154 on the finger grip lever 128 to pivot generally rearwardly (from the point of view of FIGS. 11 and 12, for example) which moves the linkage structure 138 rearwardly within the linkage receiving cavity 120.

As the linkage structure 138 moves rearwardly, the spring support structure 170 on the linkage structure 138 moves toward the spring support structures 168 on the main body 112 which compresses the coil spring 140. The rearward movement of the linkage structure 138 also moves the cutting member 126 rearwardly toward the blade 124 which causes the surface 141 to move the workpiece toward and against the cutting edge 200 of the cutting blade 124.

When the finger grip lever 128 is moved to its actuated position (see FIG. 12, for example), the workpiece engaging surface 141 on the cutting member 126 is positioned against the cutting surface 200 of the blade 124 so that when the finger grip lever 128 is in its actuated position, the workpiece is severed. The notch 135 in the blade carrier 125 is provided to allow the cutting member 126 to move to a position in which the surface 141 thereof is against the cutting edge 200 of the blade 124.

When the worker releases the finger grip lever 128, the spring force exerted by the coil spring 140 on both the spring support structure 168 of the main body 112 and the spring support structure 170 of the linkage structure 138 causes the linkage structure 138 to move relative to the main body 112 forwardly within the linkage receiving cavity 120. This spring biased movement of the linkage structure 138 causes the cutting member 126 to move back to its open position in which it is spaced from the cutting edge 200 of the blade 124 and causes the finger grip lever 128 to pivot back to the position that corresponds to the open position of the cutting member 126 with respect to the blade 124, that is, to its non-actuated position.

The blade carrier 125 is movable between an engaged position (see FIG. 10, for example) in which it securely holds the blade 124 in an operative position generally across the linkage receiving cavity 120 and in the travel path of the cutting member 126 and a disengaged position (see FIG. 11, for example) in which the blade carrier 125 and blade 124 are removed from the pruners 100. When the blade carrier 125 is in its engaged position, an end portion 182 of the blade carrier 125 extends outwardly of the main body portion 112.

To replace the blade 124, the worker grasps the end portion 182 of the blade carrier 125 and pulls the blade carrier 125 out of its slot 127. It can be understood that the slot 127 includes structure on both sides of the linkage receiving cavity 120 that secures respective end portions of the blade carrier 125 in its operative engaged position. In the illustrative pruner 100, portions of the slot 127 are located on each side of the linkage receiving cavity 120. The blade carrier 125 can be removed from the main body 112 to facilitate blade replacement. To replace the blade, the worker pushes the old blade out of the blade recess 129 and out of engagement with the posts 131 on the blade carrier 125 and then presses a new blade into the recess 129 into engagement with the posts 131. The posts 131 and/or the recess 129 of the blade carrier 125 may be constructed to provide an interference fit with or a snap-fit engagement with the blade 124. The worker then reinserts the blade carrier 125 and blade 124 back into the slot 127.

The blade carrier 125 and the main body 112 may be constructed such that when the blade carrier 125 is in its operative engaged position in the main body slot 127, in the blade carrier 125 releasably locks in its operative position.

The pruners 100 may optionally include a releasable lock (not shown) to releasably lock the workpiece carrying structure in its closed position. It should be noted, however, that the cutting edge 200 of the blade is not exposed when the pruners 100 is in its non-actuated position so the worker will not be injured when the pruners 100 is in this position. The releasable lock may be operatively connected to the linkage structure 138 and/or to the finger grip lever 128, for example. The releasable lock may be carried on the main body 112 and movable between a locked position wherein the releasable lock retains the cutting member 126 in its closed position against the biasing of the spring structure 140 and retains the finger grip lever 128 in a position corresponding to the closed position of the cutting member 126 and an unlocked position wherein the cutting member 126 is movable between is open and closed positions and the finger grip lever 128 is movable between the positions corresponding to the open and closed positions of the cutting member 126.

It can be appreciated that the pruners 100 is illustrative only and not intended to limit the scope of the invention. Other variations and embodiments are contemplated. For example, the pruners 100 could be constructed so that the blade is mounted on the linkage structure and the anvil structure is in a fixed position on the main body.

It can be understood that the embodiments shown herein are illustrative only have not intended to limit the scope of the invention. For example, the components of each pruner can be made from a wide range of materials including a wide range of molded plastics of suitable strength and properties, a wide range of metal materials, or any other materials of suitable strength. For example, the pruners 100 can be constructed of molded plastic, except for the blade, the coil spring, and the fasteners. Similarly, the pruners 10 may be constructed of a molded plastic. The coil spring may be constructed of an appropriate metal. The blade members may be constructed on various materials including, for example, a plastic, a metal, or any other suitable material.

While the invention has been disclosed and described with reference with a limited number of embodiments, it will be apparent that variations and modifications may be made thereto without departure from the spirit and scope of the invention and various other modifications may occur to those skilled in the art. Therefore, the following claims are intended to cover modifications, variations, and equivalents thereof.

What is claimed:

1. A hand-operated pruner for trimming vegetation, said pruner comprising:
a main body formed of rigid material and providing a blade mounting portion at a forward end thereof, a finger grip lever mounting portion at a rearward end thereof distal said blade mounting portion, a hand grip portion extending rearwardly from said blade mounting portion between said blade mounting portion and said finger grip lever mounting portion, and a linkage receiving cavity extending through said hand grip portion at least from said lever mounting portion to said blade mounting portion, said hand grip portion providing an exterior palm engaging surface configured to enable a user performing a vegetation cutting operation to engage a palm of his or her hand therewith;
a pair of cooperating cutting members including at least one cutting blade;
said cutting members each being mounted to said blade mounting portion of said main body for relative movement with respect to one another between an open position in which said cutting members are spaced apart from one another to enable vegetation to be positioned therebetween and a closed position in which said cutting members are adjacent one another, said cutting members cooperating with one another to sever vegetation positioned therebetween as said cutting members move from their open position toward and into their closed position to thereby perform said vegetation cutting operation;
a finger grip lever formed of rigid material and pivotably mounted at a rearward end thereof to said finger grip lever mounting portion of said main body so as to extend forwardly therefrom and terminate in a free end, said finger grip lever being pivotable toward and away from said main body between a non-actuated position in which said lever forms a relatively larger angle with said main body, and an actuated position in which said lever forms a relatively smaller angle with said main body, said finger grip lever and said main body being constructed and arranged such that when a palm of a gripping hand of a user is engaged with said palm engaging surface between said blade mounting portion and said finger grip lever mounting portion, a plurality of fingers of the gripping hand are positioned on the finger grip lever such that when the user moves the finger grip lever from its non-actuated position toward and into its actuated position, an index finger of the user is positioned at or near the free forward end of the finger grip lever;
a linkage structure extending through said linkage receiving cavity of said main body and operatively interconnecting said finger grip lever with at least one of said cutting members such that pivotal movement of said finger grip lever from its non-actuated position toward and into its actuated position causes relative movement between said cutting members toward and into their closed position; and
spring structure biasing said finger grip lever toward and into its non-actuated position and biasing said cutting members relative to one another toward and into their open position.

2. A hand-operated pruner as recited in claim 1, further comprising a releasable lock carried on said main body and movable between (a) a locked position wherein said lock retains said cutting members in their closed position and retains said finger grip lever in the actuated position thereof against the biasing of said spring structure and (b) an unlocked position wherein said cutting members are movable between said open and closed positions and said finger grip lever is movable between said actuated position and said non-actuated position.

3. A hand-operated pruner as recited in claim 2, wherein said cutting blade is fixedly mounted to said main body and wherein the other cutting member is pivotally mounted to the blade mounting portion of the handle.

4. A hand-operated pruner as recited in claim 3, wherein the other cutting member is a second cutting blade.

5. A hand-operated pruner as recited in claim 3, wherein the other cutting member is an anvil.

6. A hand-operated pruner as recited in claim 2, wherein said cutting blade is pivotally mounted to said main body and wherein the other cutting member is fixedly mounted to the blade mounting portion of the handle.

7. A hand-operated pruner as recited in claim 6, wherein the other cutting member is an anvil.

8. A hand-operated pruner as recited in claim 6, wherein the other cutting member is a second cutting blade.

9. A hand-operated pruner as recited in claim 2, wherein said cutting blade is pivotally mounted to said main body and wherein the other cutting member is pivotally mounted to the blade mounting portion of the handle.

10. A hand-operated pruner as recited in claim 9, wherein the other cutting member is an anvil.

11. A hand-operated pruner as recited in claim 9, wherein the other cutting member is a second cutting blade.

12. A hand-operated pruner as recited in claim 2, wherein both said cutting members are mounted within a forward end of said linkage receiving cavity, said linkage receiving cavity including an opening constructed and arranged to allow vegetation to be positioned between the cutting members in their open position.

13. A hand-operated pruner as recited in claim 12, wherein said cutting blade is fixedly mounted and wherein the other cutting member is movably mounted in said linkage receiving cavity.

14. A hand-operated pruner as recited in claim 13, wherein the other cutting member is an anvil.

15. A hand-operated pruner as recited in claim 14, wherein said anvil is directly connected to said linkage structure.

16. A hand-operated pruner as recited in claim 13, wherein the aforesaid cutting blade is a first cutting blade and wherein the other cutting member is a second cutting blade.

17. A hand-operated pruner as recited in claim 16, wherein said second cutting blade is mounted to said linkage structure.

18. A hand-operated pruner as recited in claim 13, further comprising a blade carrier removably mounted to said main body for movement between engaged and disengaged positions with respect thereto, said cutting blade being removably mounted on said blade carrier so that when the blade is mounted on the blade carrier and the blade carrier is engaged with said main body, said blade is positioned in the linkage receiving cavity as aforesaid and such that when said blade carrier is disengaged from said main body, said blade can be removed from said blade carrier and replaced with a new blade.

19. A hand-operated pruner as recited in claim 12, wherein said cutting blade is movably mounted and wherein the other cutting member is fixedly mounted in said linkage receiving cavity.

20. A hand-operated pruner as recited in claim 19, wherein said other cutting member is an anvil.

21. A hand-operated pruner as recited in claim 20, wherein said blade is directly connected to said linkage structure.

22. A hand-operated pruner as recited in claim 12, wherein said cutting blade is movably mounted and wherein the other cutting member is movably mounted in said linkage receiving cavity.

23. A hand-operated pruner as recited in claim 22, wherein said other cutting member is an anvil.

24. A hand-operated pruner as recited in claim 22, wherein said other cover member is a second cutting blade.

25. A hand-operated pruner as recited in claim 2, wherein said main body and said finger grip lever are each of one-piece integral construction

26. A hand-operated pruner as recited in claim 25, wherein said main body and said finger grip lever are each constructed of a molded plastic material.

27. A hand-operated pruner as recited in claim 2, wherein said cutting blade is removably mounted to said blade mounting portion so that said cutting blade can be removed therefrom and replaced with a new blade.

28. A hand-operated pruner as recited in claim 2, wherein both of said cutting members are cutting blades and wherein each cutting blade is removably mounted to said blade mounting portion so that each said cutting blade can be removed therefrom and replaced with a new blade.
